(19) United States
(12) Patent Application Publication
(10) Pub. No.: US 2006/0143922 A1
(43) Pub. Date: Jul. 6, 2006

(54) Methods and apparatus for disassembling a container

(76) Inventor: Wayne W. Chou, Ridgefield, CT (US)

Correspondence Address: Mark P. Stone, 4th Floor, 25 Third Street, Stamford, CT, 06905, US

(21) Appl. No.: 11/028,404

(22) Filed: Jan. 3, 2005

(51) Int. Cl. B67B 7/00

(52) U.S. Cl. 30/2

(57) ABSTRACT

A tool for disassembling a container, and in particular, a container for a compact disk (CD) or a digital video disk (DVD), has a longitudinally extending handle and at least one tab projecting from the handle and oriented substantially perpendicular to the handle. The tab is insertable between a container sidewall and an insert received within one section of the container. The insert is both separated from the sidewall of the container section to disengage the insert from the container and removed from the container section in one continuous pivoting movement of the tool relative to the container section.

### BACKGROUND OF THE INVENTION

A conventional container for a compact disk (CD) or a digital video disk (DVD) is formed from two half housing sections (a top and bottom section) pivotably mounted to each other for opening and closing the container. The half sections include sidewalls so as to define an enclosed volume of space when the container is in it closed position. An insert for receiving a compact disk or digital video disk is removably mounted within one of the half sections of the container and snap fitted into engagement with opposed sidewalls of that half section. The container and the removable insert are formed from a somewhat flexible material (e.g., plastic) so that they can be flexed to a limited degree.

In many instances it is desirable to remove the insert from the container half section for placing a label or other identifying indicia between the insert and the container half section. The container is formed from a transparent material, usually plastic, and therefore the indicia placed between the insert and the container will be visible from the outside of the container, and also will be protected because it is disposed within the container and not merely applied to the outside of the container. Moreover, the indicia within the container can be removed and replaced with other identifying indicia at the selection of the user, as for example, when the original content of the CD or DVD housed within the container is changed.

It is the primary object of the present invention to provide methods and apparatus for easily removing the insert from the container to readily enable the user to place or replace identifying indicia between the insert and the transparent half section of the container in which the insert is removably received. Further objects and advantages of the present invention will become apparent from the following description in connection with the accompanying drawings.

### SUMMARY OF THE INVENTION

The present invention is directed to methods and apparatus for disassembling a container for a compact disk (CD) or a digital video disk (DVD). Conventional holders for CD's or DVD's include first and second housing sections pivotably mounted together for moving the housing sections relative to each other for opening and closing the containers. The housing sections are generally transparent, and a flexible insert for the CD or DVD is removably received within one of the housing sections. Generally, the insert is snap fitted into engagement with opposed sidewalls of the housing section in which the insert is mounted.

A tool for disassembling the insert from the housing section includes a generally longitudinally extending handle and at least one (1) tab projecting from the handle and extending along a plane substantially perpendicular to the plane of the handle. In the preferred embodiment of the invention, two tabs project from the handle, the first tab extending from the handle proximate to one remote end thereof, the second tab extending from the handle proximate to the opposed remote end thereof. The tabs are insertable between one of the opposed sidewalls of the housing section engaging the insert and the adjacent sidewall of the insert. A force applied to the longitudinally extending handle results in a prying action which initially separates the sidewall of the insert from the sidewall of the housing section resulting in disengagement of the insert from the housing section, and thereafter removes the insert from the housing section by lifting it in a single continuous motion.

Although not essential to the removal of the insert from the housing section, the tool may also include a blade extending outwardly from about the center region of the longitudinal handle and at least one guide element extending from the handle and surrounding the blade. Preferably, the blade is serrated, and extends along a plane substantially perpendicular to the plane of the surrounding guide element. The guide element is placed on one edge of a container for a CD or DVD which has not previously been opened, and is still enclosed within its original shrink wrap material. As the tool is slid along the edge of the container with the guide element engaging the edge of the container, the blade cuts the original shrink wrap packaging for readily removing it from the original container. Preferably, the tabs, guides and blade extend from the same edge of the tool to facilitate manufacture of the tool, although the tabs and guide are oriented at different angular inclinations or elevations so that the tabs do not contact the container when the guides and blade are operating on the container, and the guides and blade do not contact the container when the tabs are inserted into the container to remove the insert mounted therein. The tool itself can be formed from any suitable material, including a lightweight metal such as stainless steel, or plastic such as RYNITE produced by the Dupont Company. The blades, guides and cutting edge can be formed from any conventional manufacturing process such as stamping, forming or casting.

### BRIEF DESCRIPTION OF THE DRAWINGS

FIG. 1 illustrates a perspective view of a tool in accordance with the preferred embodiment of the present invention;

FIG. 2 illustrates a top plan view of the tool shown in FIG. 1;

FIG. 3 illustrates a front elevational view of the tool shown in FIG. 1;

FIG. 4 illustrates a side elevational view of the tool shown in FIG. 1;

FIG. 5 illustrates the tool shown in FIG. 1 in which the tool is inserted into a container; and

FIG. 6 illustrates movement of the tool shown in FIG. 5 to remove an insert from the container.

### DESCRIPTION OF THE BEST MODES FOR CARRYING OUT THE INVENTION

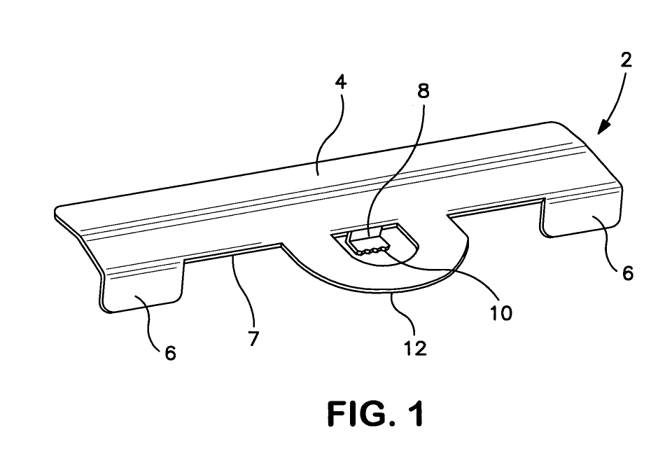

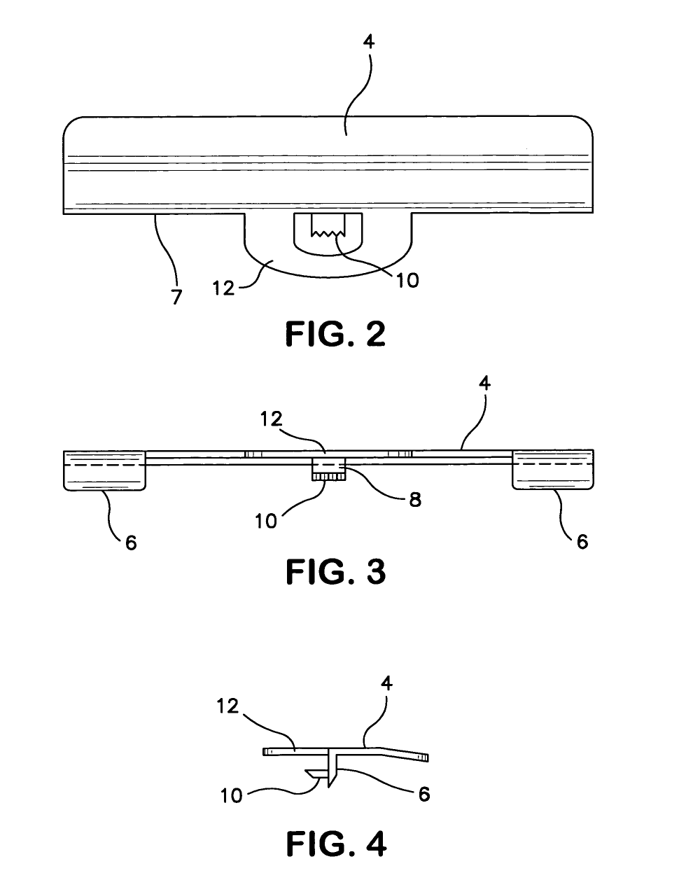

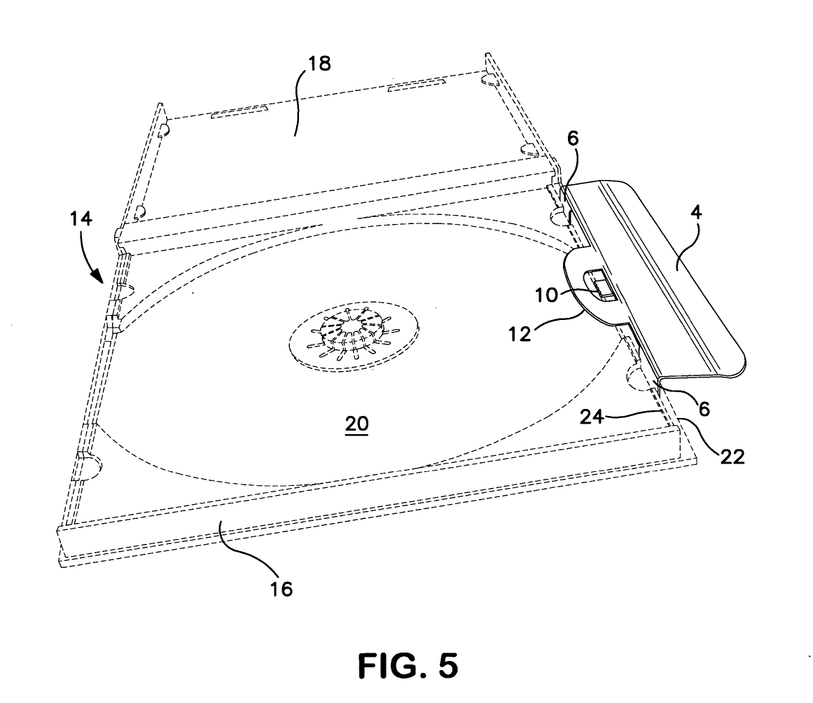

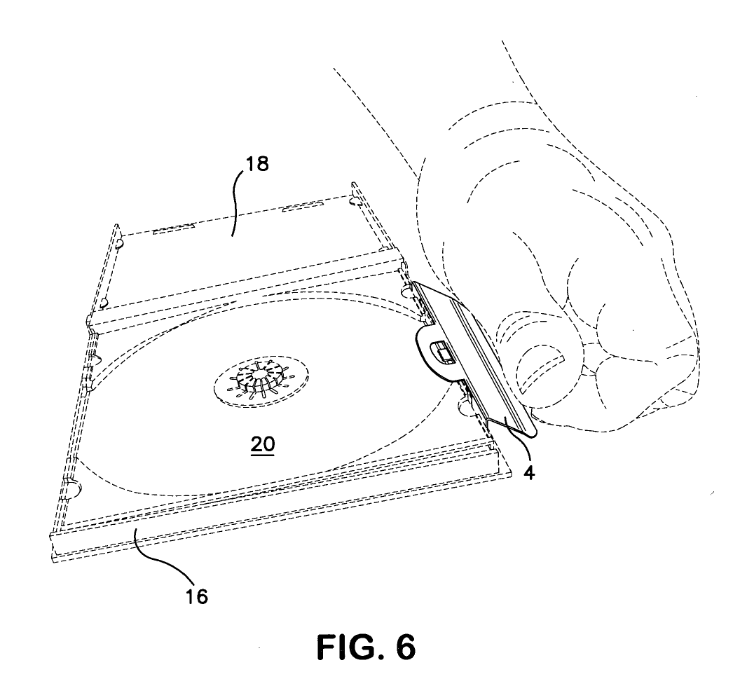

FIGS. 1-4 illustrate a tool in accordance with the preferred embodiment of the present invention, while FIGS. 5-6 illustrate the tool being used to disassemble a container for a compact disk (CD) or a digital video disk (DVD).

The tool is generally designated by reference numeral 2. It includes a longitudinally extending handle designated by reference numeral 4. The handle is slightly contoured from front to rear. A pair of tabs, designated by reference numeral 6, extend from a forward edge 7 of the handle proximate to the opposed remote ends of the handle. Preferably, the tabs are tapered towards the forward ends thereof. The tabs are oriented along a plane substantially perpendicular to the plane along which the handle extends. Preferably, the tabs are oriented at an angle between 75°-90° relative to the handle. In the preferred embodiment of the invention, the tabs 6 are integrally formed with the handle 4, as for example, by a conventional stamping, casting or forming process. Preferably, the handle and the tabs are formed from a lightweight, inexpensive metal, as for example, stainless steel, or from a lightweight, inexpensive durable plastic.

A cutting element designated by reference numeral 8 extends from the proximate center of the forward edge 7 of the handle. The cutting element defines a serrated cutting edge designated by reference numeral 10. The cutting element includes a first portion extending downwardly from and substantially perpendicular to the longitudinally extending handle, and a second portion which defines the serrated edge 10 and extends forwardly of the forward edge of the handle along a plane substantially parallel to the plane of the handle. A guide element designated by reference numeral 12 extends forwardly of the forward edge of the handle, along substantially the same plane as the handle. The guide element is elevated above the serrated edge of the cutting element, and surrounds the serrated edge. As shown in the drawings, the guide element 12 is arcuate, and generally “D” shaped. The guide element and the cutting element can be formed from a conventional stamping process. As will be discussed herein, the guide element is employed to slide the tool along an edge of a container so that the serrated edge of the cutting element engages and tears shrink wrap enclosing a container. By configuring the guide element in an arcuate configuration which surrounds the cutting element, the guide element performs the added function of protecting the fingers and hands of a user from the serrated edge of the cutting element. However, it is also with the scope of the present invention to eliminate the arcuate connecting portion of the guide element so that the guide element is formed by only two projections extending forwardly of the forward edge of the tool at opposed sides of the cutting element. Moreover, as will also be discussed herein, both the guide element and cutting element are not essential components of the present invention.

Preferably, the cutting element 8, the guide 12 and the tabs 6 are integrally formed with the handle 4, as for example, by a conventional stamping process. The cutting element 8 and the guides 12 are also formed from the same material as the handle 4 and the tabs 6, as for example, a lightweight, inexpensive metal, such as stainless steel, or suitable plastic.

Referring now to FIG. 5-6 of the drawings, the tool 2 is shown together with a conventional container for a CD or DVD. The container is generally designated by reference numeral 14 and includes a bottom section 16 and a top section 18 which is pivotably mounted to one side of the bottom section. The holder 14 is opened or closed, at the selection of the user, by pivoting the top section 18 relative to the bottom section 16. An insert generally designated by reference numeral 20 is removably received within the bottom section 16 of the holder 14. The insert defines a recessed section configured for removably receiving a CD or DVD therein. The insert 20 is removably received within the bottom section 18 of the holder by conventional means, as for example, snap fitting by which projections extending inwardly from a sidewall of the bottom section of the holder are received within openings in the adjacent sidewall of the removable insert. Both the bottom section of the holder and the insert are formed from a somewhat flexible material, as for example plastic, and therefore the insert can be flexed relative to the bottom of the container to disengage the projections from the corresponding openings.

FIG. 5 of the drawings shows the tabs 6 of the tool 2 inserted between a sidewall 22 of the bottom 16 of the holder and an adjacent sidewall 24 of the removable insert 20. Insertion of the tabs 6 between the sidewalls 22 and 24 is aided by the taper in the tabs. Thereafter, as illustrated by FIG. 6, a downward force is applied to the top surface of the handle 4, causing the handle to pivot in a clockwise direction as seen in the drawing. This movement causes the tabs 6 to also pivot in a clockwise direction, causing the respective projections and openings of the adjacent sidewalls to separate and disengage from each other, and also lifting the insert 20 from the bottom section 16 of the container as result of frictional engagement and prying action between the tabs and the insert. The insert 20 is therefore removed from the bottom of the holder, at the selection of the user, in a single continuous movement of the tool relative to the bottom section of the holder. Preferably, the tabs 6 are oriented relative to the handle 4 so that the tabs are proximate to the snap fit locking elements of the holder and removable insert when the tabs are inserted between the adjacent sidewalls.

A holder 14 for a CD or DVD typically is enclosed in a thin plastic material, as for example by a shrink wrapping process, when the CD or DVD is originally purchased by a consumer. The centrally disposed cutting element 8 and the guide element 12 are provided to remove the original shrink wrap from the holder 14. The guide element 12 is positioned on one edge of the holder, and slid along the edge. The serrated edge 10 of the cutting element 8 engages the shrink wrap as the tool is slid along the edge of the holder, causing a partial tear or perforation in the shrink wrap which enables the user to remove the shrink wrap from the original packaging. The cutting element 8, the guide 12, and the tabs 6 extending from the forward edge of the handle are arranged so that the guide 12 and the cutting element 8 do not interfere with the operation of the tabs 6, and the tabs 6 do not interfere with the operation of the guide 12 and the cutting element 8. Although the tabs and cutting element are shown extending from the same forward edge of the handle, it is also possible to arrange the tabs and cutting element to extend from different opposed edges of the handle.

It is noted that the cutting element 8 and the guide 12 are not essential to the operation of the invention. Therefore, in a less preferred embodiment of the invention, the cutting element 8 and guide element 12 can be omitted entirely, or can be replaced by a third tab 6 extending from the center region of the handle 4. As also noted above, the arcuate center portion of the guide can be eliminated so that the guide is formed by a pair of projections extending from the front edge of the handle on opposed sides of the cutting element.

Although the preferred embodiment of the invention is directed to a tool having tabs 6 extending from opposed ends of the handle 4, it is also within the scope of the present invention to provide a tool in which three or more tabs extend from the handle, as for example, a third tab extending from the center of the forward edge of the handle. It is also within the scope of the invention to provide a tool in which only a single tab extends from the handle. Preferably, the single tab will be disposed in the region of the center of the forward edge of the handle. It is also within the scope of the present invention to provide a tool having a tab extending along the entire length of the forward edge of the handle. The only constraint on the size of the tab is that it not be longer than the side of the holder 14 in which the tab is to be inserted.

The tool in accordance with the present invention enables a user to readily remove the insert 20 from the bottom section 16 of the holder 14. The bottom section of the holder is conventionally formed from a transparent material such as plastic. By enabling a user to easily remove the insert 20 from the bottom of the holder, the user can insert or replace material between the bottom of the insert 20 and the inner surface of the bottom section 16 of the holder. For example, the materials inserted between the removable insert 20 and the bottom of the holder can include labels or other indicia identifying the title or content of the CD or DVD stored within the holder. When the title and/or content of the CD or DVD is changed, the indicia inserted between the removable insert of the holder can readily be replaced by other indicia identifying the changed title or content. Storing such identifying indicia within the holder itself is significantly more secure, less expensive, and more convenient than applying the indicia to the outer surface of the holder by, for example, glued labels. Moreover, it is significantly easier to replace identifying indicia within the holder since it is necessary to permanently affix the identifying indicia within the holder. On the contrary, the identifying indicia is retained between the removable insert and the bottom section of the holder by frictional engagement alone. Therefore, the tool in accordance with the present invention facilitates storage and replacement of identifying indicia within the holder itself by facilitating the removal of the insert from the bottom section of the holder.

Other modifications to the methods and apparatus disclosed herein falling within the scope of the invention will be apparent to those skilled in the art. Accordingly, the preferred embodiments of the invention herein discussed herein and illustrated by the drawings is intended to be illustrative only, and not restrictive of the scope of the invention, that scope being defined by the following claims and all equivalents thereto.

1. A tool for disassembling a holder for a CD (compact disk) or DVD (digital video disk) comprising top and bottom holder sections pivotably mounted to each other, and an insert removably received within one of said holder sections, said tool including:
a handle, and
at least one tab extending from said handle adapted to be inserted between adjacent surfaces of said one holder section and said removable insert received therein for removing said insert from said one holder section.

2. The tool as claimed in claim 1 wherein said at least one tab extends from said handle at an angle substantially perpendicular relative to said handle.

3. The tool as claimed in claim 2 wherein said handle is oriented to extend in a substantially longitudinal direction.

4. The tool as claimed in claim 1 further including at least two tabs extending from said handle, each of said tabs extending from the same edge of said handle and oriented along substantially the same plane relative to said handle.

5. The tool as claimed in claim 4 wherein each of said at least two tabs is oriented at an angle substantially perpendicular to said handle.

6. The tool as claimed in claim 4 wherein one of said two tabs extends from one end of said handle, and the other of said two tabs extends from an opposed end of said handle.

7. The tool as claimed in claim 4 further including a cutting element extending from said handle.

8. The tool as claimed in claim 7 wherein said cutting element extends from said handle at the proximate longitudinal center of said handle.

9. The tool as claimed in claim 8 wherein said cutting element extends from the same edge of said handle as said two tabs, and said cutting element is disposed equidistantly between said two tabs.

10. The tool as claimed in claim 7 wherein said cutting element defines a cutting edge which extends along a plane substantially parallel to the plane along which said handle extends.

11. The tool as claimed in claim 7 further including at least one guide element for said cutting element, said guide element extending from said handle proximate to said cutting element.

12. The tool as claimed in claim 11 further including at least two guide elements, said guide elements disposed along opposed sides of said cutting element, said guide elements extending along a plane substantially corresponding to the plane along which said handle extends.

13. The tool as claimed in claim 12 wherein said guide elements extend along a plane substantially perpendicular to the plane from which said tabs extend from said handle.

14. The tool as claimed in claim 1 wherein said at least one tab is tapered in a direction towards a forward end thereof.

15. A method of using a tool for disassembling a holder for a CD (compact disk) or a DVD (digital video disk), said holder comprising first and second holder sections pivotably mounted to each other, and an insert removably received within one of said holder sections such that a sidewall of said one holder section is adjacent to a sidewall of said removable insert; said tool including a handle and at least one tab extending from said handle;
the steps of said method comprising:
inserting said tab of said tool between said adjacent sidewalls of said one holder section and said insert removably received therein.

16. The method as claimed in claim 15, further including the step of:
applying a force to said handle for moving said tab inserted between said adjacent sidewalls for removing said insert from said one holder section.

17. A method of disassembling a holder for a CD (compact disk) or DVD (digital video disk), said holder comprising first and second holder sections pivotably mounted to each other, and a removable insert releasably locked within one of said holder sections;
the steps of said method comprising:
providing a tool having a handle and at least one tab extending from said handle at an angle relative to said handle; and
inserting said tab between adjacent sidewalls of said one holder section and said removable insert therein.

18. The method as claimed in claim 17 further including the step of applying a force to said handle for separating said adjacent sidewalls and disengaging releasable locking means on said one holder section and said removable insert received therein.

19. The method as claimed in claim 18 wherein the step of applying a force to said handle moves said tab extending from said handle relative to said one holder section.

20. The method as claimed in claim 19 wherein the step of applying a force to said handle includes the step of removing said insert from said one holder section as a result of said movement of said tab extending from said handle relative to said one holder section.
